(19) United States
(12) Patent Application Publication
(10) Pub. No.: US 2011/0016261 A1
(43) Pub. Date: Jan. 20, 2011

(54) PARALLEL PROCESSING ARCHITECTURE OF FLASH MEMORY AND METHOD THEREOF

(75) Inventors: Jin-min Lin, Taipei City (TW); Wei-kan Hwang, Taipei City (TW)

Correspondence Address: AUSTIN RAPP & HARDMAN, 170 South Main Street, Suite 735, SALT LAKE CITY, UT, 84101, US

(73) Assignee: Genesys Logic, Inc., Shindian City (TW)

(21) Appl. No.: 12/554,197

(22) Filed: Sep. 4, 2009

(30) Foreign Application Priority Data
Jul. 17, 2009 (TW) 098124229

(51) Int. Cl. G06F 12/02; G06F 12/00

(52) U.S. Cl. 711/103; 711/115; 711/E12.001; 711/E12.008; 711/202

(57) ABSTRACT

A parallel processing architecture of flash memory and method thereof are described. A processing unit classifies a plurality of commands to generate a first command group and a second command group respectively. The processing unit executes the first command group and the second command group. A first control unit performs the first command group to access the data stored in the first memory unit, and a second control unit simultaneously performs the second command group to access the data stored in the second memory unit for processing the data stored in the first and the second memory units in parallel.

### CLAIM OF PRIORITY

This application claims priority to Taiwanese Patent Application No. 098124229 filed on Jul. 17, 2009.

### FIELD OF THE INVENTION

The present invention relates to a data processing architecture and method thereof, and more particularly relates to a parallel processing architecture and method thereof for flash memory.

### BACKGROUND OF THE INVENTION

With the rapid development of flash memory, more and more electronic products are equipped with flash memory to be served as storage media. For an example of NAND (Not AND) flash memory, when applying to version 2.0 or prior versions of Universal Serial Bus (USB) protocol, one controller is utilized to control one chip of NAND flash memory. However, version 2.0 or prior versions of USB protocol only supports one command and a data stream for processing the data stored in the flash memory. That is, during a time interval, the controller only performs a command and processes a data stream but cannot perform a plurality of commands and process multiple input/output data streams. Thus, accessing speed of the flash memory is restricted considerably. In addition, before the controller writes the data to the NAND flash memory, the controller has to erase the flash memory. However, the controller erases the flash memory based on the unit of blocks but the accessing unit of NAND flash memory is the page-by-page mode, wherein one block is composed of a plurality of pages. Therefore, the unit of writing step is inconsistent with the unit of erasing step, resulting in decreasing the accessing speed of the flash memory. Consequently, there is a need to improve the accessing speed of conventional flash memory to solve the aforementioned problems.

### SUMMARY OF THE INVENTION

One objective of the present invention is to provide a parallel processing architecture and method thereof for performing a plurality of commands and processing multiple input/output data streams during a time interval to increase the accessing speed of the flash memory.

Another objective of the present invention is to provide a parallel processing architecture and method thereof so that the unit for accessing the flash memory is the same as the unit for erasing the flash memory to increase the accessing efficiency of the flash memory.

According to the above objectives, the present invention sets forth a parallel processing architecture and method thereof. The parallel processing architecture includes a command buffer, a processing unit, a program module, a look-up table, a first control unit, a second control unit, a first memory unit and a second memory unit. The command buffer stores a plurality of commands and each command has a logical address parameter to indicate the stored addresses of the data to be accessed by the command. The processing unit classifies the commands to generate a first command group and a second command group. The first command group is associated with a first data address group and the second command group is associated with a second data address group. The first data address group is composed of a plurality of first logical address blocks and the second data address group is composed of a plurality of second logical address blocks. The first memory unit is coupled to the first control unit and has a plurality of first physical blocks which have a first physical address range. The first data address group corresponds to the first physical address range and the processing unit executes the first command group to allow the first control unit to access the data corresponding to the first physical address range. The second memory unit is coupled to the second control unit and has a plurality of second physical blocks which have a second physical address range. The second data address group corresponds to the second physical address range and the second control unit simultaneously accesses the data corresponding to the second physical address range when the first control unit accesses the data corresponding to the first physical address range of the first memory unit.

The parallel processing method of flash memory in the present invention includes the steps of:

(a) temporarily storing a plurality of commands in a command buffer;

(b) utilizing the look-up table to inquire the relationship between the logical address and physical address;

(c) classifying the commands by a processing unit to generate a first command group and a second command group, wherein the first command group is associated with a first data address group and the second command group is associated with a second data address group, and the first data address group is composed of a plurality of first logical address blocks and the second data address group is composed of a plurality of second logical address blocks;

(d) receiving the first command group by a first control unit and receiving the second command group by a second control unit;

(e) executing the first command group by a processing unit to allow the first control unit to access the data corresponding to the first physical address range of a first memory unit; and

(f) simultaneously accessing the data of a second memory unit corresponding to the second physical address range by the second control unit when the first control unit accesses the data corresponding to the first physical address range of the first memory unit. The second memory unit has a plurality of second physical blocks which have a second physical address range corresponding to the second data address group.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view of a parallel processing architecture of flash memory according to a first embodiment of the present invention;

FIG. 2 is a schematic view of a parallel processing architecture of flash memory according to a second embodiment of the present invention;

FIG. 3 is a schematic detailed view of the command buffer according to one embodiment of the present invention;

FIG. 4 is a schematic view of a parallel processing architecture of flash memory according to a third embodiment of the present invention;

FIG. 5 is a schematic view of the memory card device having the parallel processing architecture according to one embodiment of the present invention; and

FIG. 6 is a flow chart of parallel processing method of the flash memory according to one embodiment of the present invention.

### DETAILED DESCRIPTION OF THE PREFERRED EMBODIMENTS

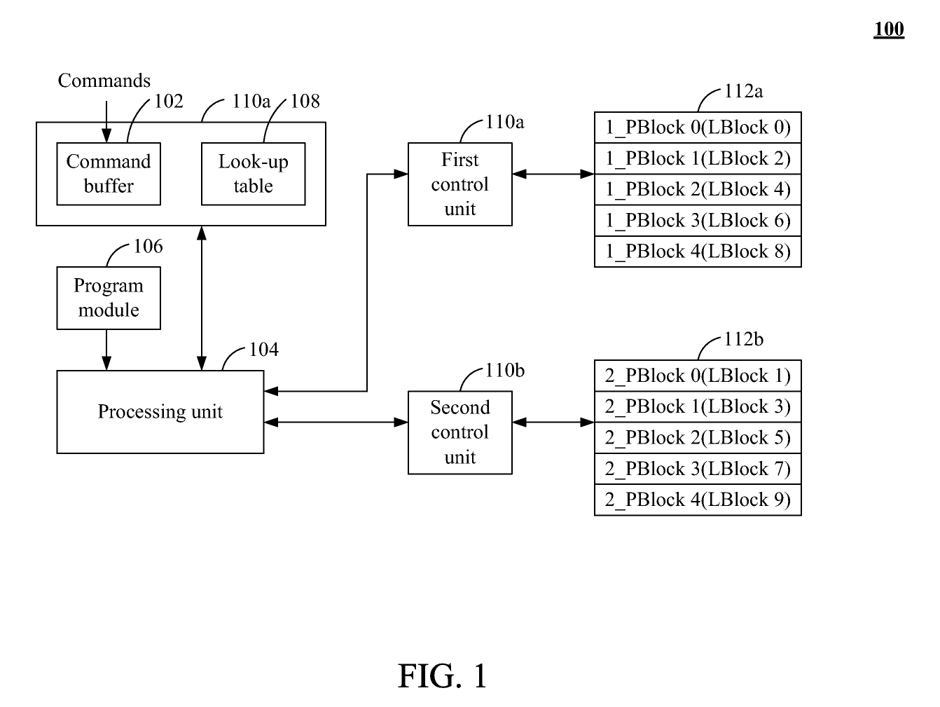

FIG. 1 is a schematic view of a parallel processing architecture 100 of flash memory according to a first embodiment of the present invention. The parallel processing architecture 100 includes a command buffer 102, a processing unit 104, a program module 106, a look-up table 108, a first control unit 110a, a second control unit 110b, a first memory unit 112a and a second memory unit 112b. The command buffer 102, the look-up table 108 and the application module 106 are coupled to the processing unit 104, respectively. The processing unit 104 is coupled to the first control unit 110a and the second control unit 110b, respectively. The first control unit 110a and the second control unit 110b are coupled to the first memory unit 112a and the second memory unit 112b, respectively. In one embodiment, the command buffer 102 and the look-up table 104 are positioned in the random access memory (RAM), e.g. dynamic random access memory (DRAM), static random access memory (SRAM), and/or various types of memory. The program module 106 is positioned in read only memory (ROM) of various types of non-volatile memory.

The command buffer 102 stores a plurality of commands and each command has a logical address parameter to indicate the stored addresses of the data to be accessed by the command. For example, the stored addresses of the data to be accessed by the command are represented by the starting address and address length. In other words, the total length computed by the starting address plus the address length indicates the data amount occupied by the logical address blocks and the data amount occupied by the corresponding physical address blocks. In one embodiment, the command buffer 102 is a queue and the commands from a host system (not shown) are stored in queue sequentially. For example, the commands are stored in the command buffer 102 according to the time when each command arrives at the processing unit 104. In one embodiment, the host system transmits the commands in form of packets and each packet records the address corresponding to the data to be accessed.

The processing unit 104 classifies the commands to generate a first command group and a second command group. The first command group is associated with a first data address group and the second command group is associated with a second data address group. The first data address group is composed of a plurality of first logical address blocks and the second data address group is composed of a plurality of second logical address blocks. The first memory unit 112a is coupled to the first control unit 110a and has a plurality of first physical blocks which have a first physical address range. The first data address group corresponds to the first physical address range and the processing unit 104 executes the first command group to allow the first control unit 110a to access the data corresponding to the first physical address range. The second memory unit 112b is coupled to the second control unit and has a plurality of second physical blocks which have a second physical address range. The second data address group corresponds to the second physical address range and the second control unit 110b simultaneously accesses the data corresponding to the second physical address range when the first control unit 110a accesses the data corresponding to the first physical address range of the first memory unit 112a.

In the parallel processing architecture 100, the look-up table 108 is used to store the corresponding relationship between the logical address blocks of the data and the physical blocks. That is, the look-up table 108 is used to store the corresponding relationship between the first logical address blocks of the data and the first physical blocks, and to store the corresponding relationship between the second logical address blocks of the data and the second physical blocks. The processing unit 104 utilizes the look-up table 108 to classify the commands based on the corresponding relationship between the first logical address blocks and the first physical blocks, and based on the corresponding relationship between the second logical address blocks and the second physical blocks.

In one embodiment, the processing unit 104 utilizes the look-up table 108 to inquire the first physical address range corresponding to the first data address group and the second physical address range corresponding to the second data address group. In other words, the processing unit 104 is capable of inquiring the relationship between the logical address and physical address of the commands from the command buffer 102 based on the look-up table 108. The first control unit 110a accesses (i.e. reads/writes) the data, e.g. the data stored in the even logical address, corresponding to the first logical address blocks based on the inquired relationship between the logical address and physical address. The second control unit 110b accesses the data, e.g. the data stored in the odd logical address, corresponding to the second logical address blocks based on the inquired relationship between the logical address and physical address.

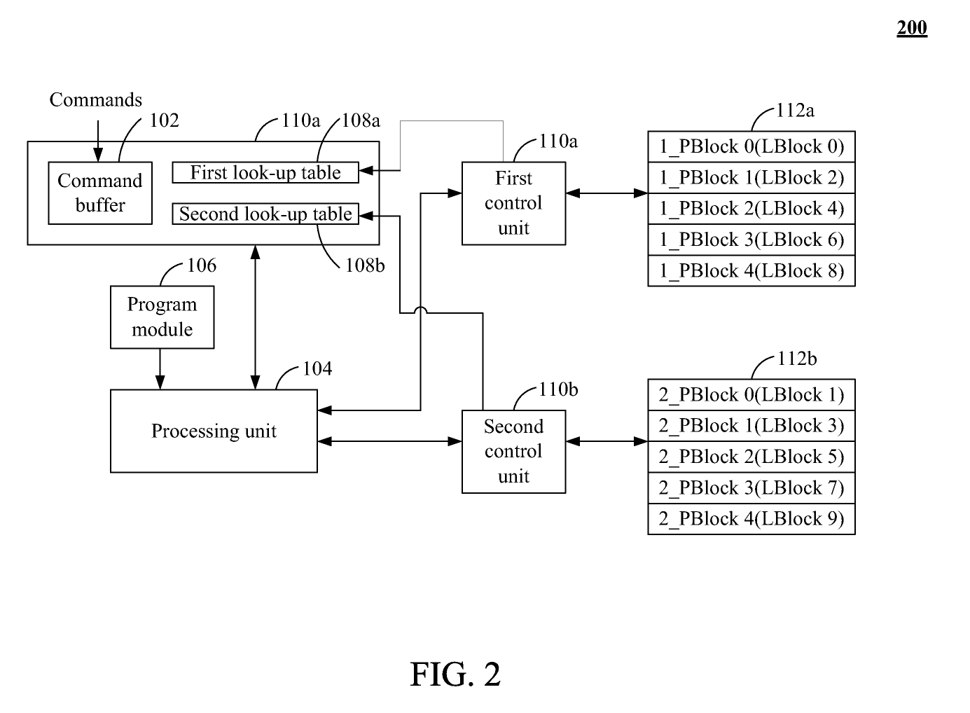

FIG. 2 is a schematic view of a parallel processing architecture 200 of flash memory according to a second embodiment of the present invention. The parallel processing architecture 200 in FIG. 2 is similar to the parallel processing architecture 100 in FIG. 1. The difference is that the look-up table 108 in FIG. 1 is replaced with the first look-up table 108a and the second look-up table 108b in FIG. 2. The first look-up table 108a is coupled to the processing unit 104 and stores the corresponding relationship between the first logical address blocks of the data. The second look-up table 108b is coupled to the processing unit 104 and stores the corresponding relationship between the second logical address blocks of the data and the second physical blocks. The processing unit 104 utilizes the first look-up table 108a and the second look-up table 108b to classify the commands based on the first logical address blocks and the second logical address blocks. The first control unit 110a utilizes the first look-up table 108a to inquire the first physical address range corresponding to the first data address group, and the second control unit 110b utilizes the second look-up table 108b to inquire the second physical address range corresponding to the second data address group. In other words, the first control unit 110a and the second control unit 110b are capable of inquiring the relationship between the logical address and physical address of the commands from the command buffer 102 based on the first look-up table 108a and the second look-up table 108b, respectively.

Please refer to FIG. 1 and FIG. 2 continuously. In one embodiment, the first physical address range and the second physical address range are positioned in form of an interlaced arrangement. For example, each physical block of the first physical address range in the first memory unit 112a corresponds to the logical address block having an even block index. The logical address blocks (i.e. LBlock 0, LBlock 2, LBlock 4, LBlock 6, and LBlock 8) having even block indexes 0, 2, 4, 6, and 8 corresponds to the physical address blocks (i.e. 1_PBlock 0, 1_PBlock 1, 1_PBlock 2, 1_PBlock 3, and 1_PBlock 4) having block indexes 0, 1, 2, 3, and 4 in the first memory unit 112a. Each physical block of the second physical address range in the second memory unit 112b corresponds to the logical address block having an odd block index. The logical address blocks (i.e. LBlock 1, LBlock 3, LBlock 5, LBlock 7, and LBlock 9) having odd block indexes 1, 3, 5, 7, and 9 corresponds to the physical address blocks (i.e. 2_PBlock 0, 2_PBlock 1, 2_PBlock 2, 2_PBlock 3, and 2_PBlock 4) having block indexes 0, 1, 2, 3, and 4 in the second memory unit 112b.

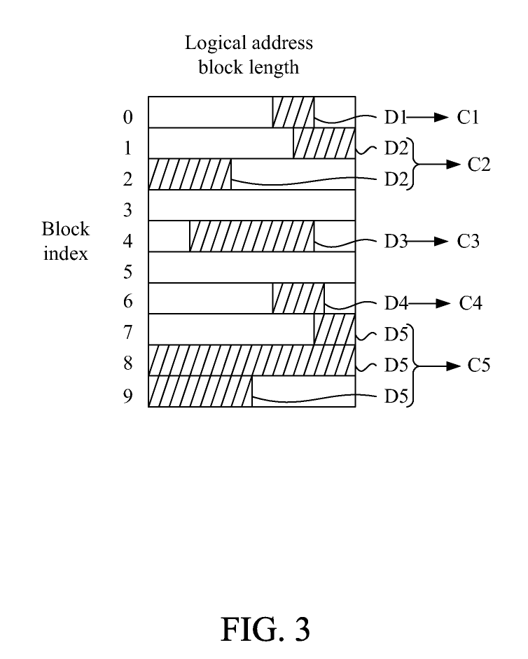

FIG. 3 is a schematic detailed view of the command buffer 102 according to one embodiment of the present invention. The vertical direction represents the block index of logical address block, such as block indexes 0 to 9 and the horizontal direction represents the length of each logical address block (LBlock). The first command C1 accesses the data D1 in the LBlock 1. The second command C2 accesses the data D2 in the LBlock 1 and LBlock 2. The third command C3 accesses the data D3 in the LBlock 4. The fourth command C4 accesses the data D4 in the LBlock 6. The fifth command C5 accesses the data D5 in the LBlock 7, LBlock 8, and LBlock 9. When the command accesses the data stored in different logical address blocks, the processing unit 104 divides the command into a plurality commands based on the different logical address blocks and the transmits the commands to first control unit 110a and the second control unit 110b based on the difference block indexes to access the memory units.

It should be noted that the block indexes of the logical address blocks corresponding to the first physical address range and the second physical address range can be arranged by arbitrary sequence. That is, that the logical address blocks corresponding to the physical address block in the first memory unit 112a are different from the of the logical address blocks corresponding to the physical address block in the second memory unit 112b is within the scope of the present invention.

In one preferred case, the units of the first physical block and the second physical block are identical to the units of the first logical address block and the second logical address block. In another case, the units of the first physical blocks are identical to the maximum memory accessing unit of an operating system (OS) which transmits the commands. Basically, the unit of the physical address range depends on the different manufacturers and the unit of the flash memory is determined when the flash memory is produced. For an example of one page equal to four kilo-bytes (KBs), one physical address block has 64 pages and one physical address block is 256 KBs which is equal to 512 sectors. In the present invention, the unit of the physical block corresponds to the unit of the logical address block. The unit of the physical block is identical to the unit of the logical address block and/or the maximum memory accessing unit of an operating system (OS). For an example of operating system of Microsoft Windows, the maximum memory accessing unit is 64 KBs and the unit of the logical address block is set as 64 KBs while the size of one physical block is equal to four logical address blocks.

When the unit of the first physical address of the first memory unit 112a and the unit of the second physical address of the second memory unit 112b are determined, the processing unit 104, the first control unit 110a and the second control unit 110b according to the look-up table (108, 108a, and 108b) can determine that the logical addresses corresponds to either the first memory unit 112a or the second memory unit 112b. The first control unit 110a and the second control unit 110b access the first memory unit 112a or the second memory unit 112b correspondingly. In one preferred embodiment, when the host system issues a plurality of commands, the processing unit 104 transmits the commands to the control unit (110a, 110b) for access operation. That is, the first control unit 110a and the second control unit 110b utilize the commands corresponding to the different address to read/write the first memory unit 112a or the second memory unit 112b. Therefore, the parallel processing architecture (100, 200) of the present invention uses the USB attached small computer system interface (SCSI) protocol (UASP) for simultaneously processing a plurality commands. It should be noted that the parallel processing architecture (100, 200) is applicable to the protocol standards which are capable of performing a plurality of commands and processing multiple input/output data streams. For example, these protocol standards include version 2.0, prior versions or latest version of USB protocol standards.

If the data accessed by the commands from the host system are dependency, the data in the prior address and the data in the next address will be accessed when the data in the current address are accessed. Thus, the next physical addresses will be accessed by the commands. As a result, based on the physical address corresponding to the logical address, the first control unit 110a and the second control unit 110b can access the first physical address and the second physical address at a high speed.

According to the above-mentioned descriptions, the first control unit 110a and the second control unit 110b access the first memory unit 112a and the second memory unit 112b, respectively. When the first control units 110a performs an accessing command to the first memory unit 112a, the second control unit 110b independently performs another accessing command to the second memory unit 112b. Further, based on the UASP, the host system transmits a plurality of commands to the command buffer 102 in a time interval and the first control unit 110a and the second control unit 110b perform the commands to generate a plurality of data streams for the first memory unit 112a and the second memory unit 112b. Therefore, the parallel processing architecture (100, 200) utilizes the UASP features of parallel process of the flash memory to increase the accessing speed of the flash memory.

In another embodiment, based on the requirements of the products, more than two control units and memory units may be used. The parallel processing architecture employs the look-up table to store the relationship between the logical address and the physical address so that the processing unit 104 classifies and executes the commands to generate a plurality of command groups, wherein the amount of command groups is equal to the amount of the control units and/or the memory units.

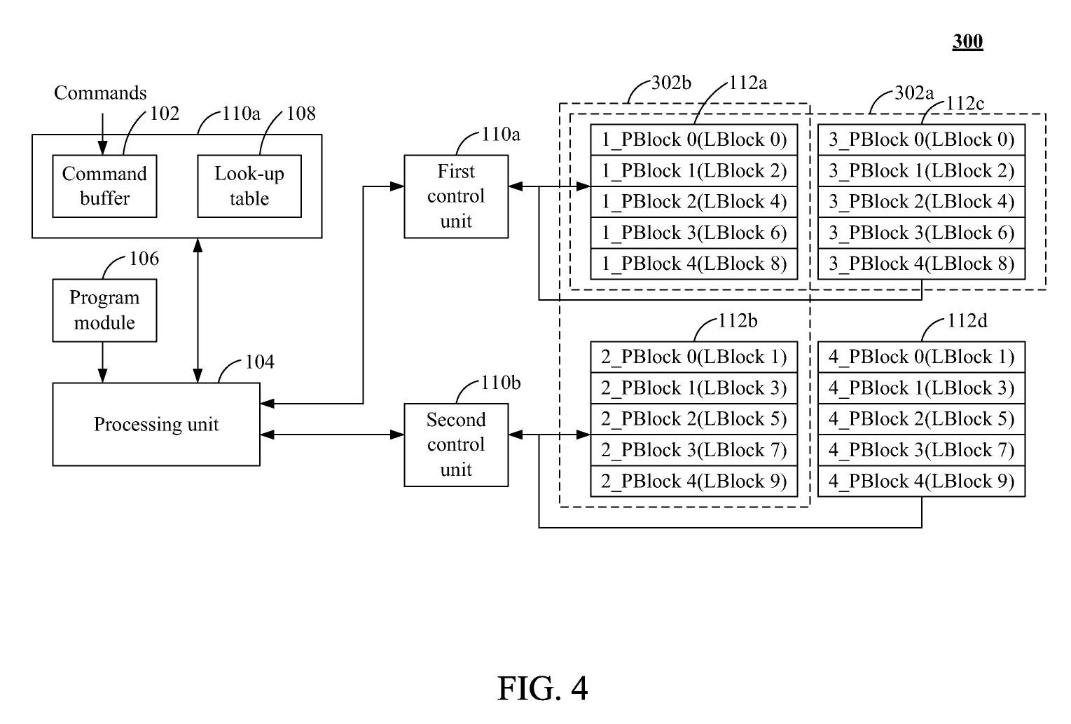

Please refer to FIG. 1 and FIG. 4. FIG. 4 is a schematic view of a parallel processing architecture 300 of flash memory according to a third embodiment of the present invention. Based on the parallel processing architecture 200 of the flash memory in the third embodiment, the parallel processing architecture 300 in the third embodiment further includes a third memory unit 112c and a fourth memory unit 112d. The third memory unit 112c is coupled to the first control unit 110a and has a plurality of third physical blocks which have the first physical address range, wherein the first data address group corresponds to the first physical address range and the processing unit 104 executes the first command group to allow the first control unit 110a to access the data of the third memory unit 112c corresponding to the first physical address range.

The fourth memory unit 112d is coupled to the second control unit 110b and has a plurality of fourth physical blocks which have the second physical address range, wherein the second data address group corresponds to the second physical address range and the second control unit 110b simultaneously accesses the data corresponding to the second physical address range when the first control unit 110a accesses the data corresponding to the first physical address range of the fourth memory unit 112d.

In one embodiment, when page strapping mode is employed to access the data, as shown in region 302a, the data bus width of the first control unit 110a is 16 bits, wherein the data width with 8 bits are sent to the first memory unit 112a and the data width with the rest of 8 bits are sent to the second memory unit 112b. That is, the first control unit 110a employs dual channel to transmit the data with 16 bits width to the first memory unit 112a and the third memory 112c respectively so that the data width of logical address corresponding to the physical address controlled by the first unit 110a is increased to be double. Similarly, the second control unit 110b employs dual channel to transmit the data with 16 bits width to the second memory unit 112b and the fourth memory 112d respectively so that the data width of logical address corresponding to the physical address controlled by the second unit 110b is increased to be double. Therefore, the parallel processing architecture (100, 200) utilizes the UASP features of parallel process of the flash memory to increase the accessing speed of the flash memory.

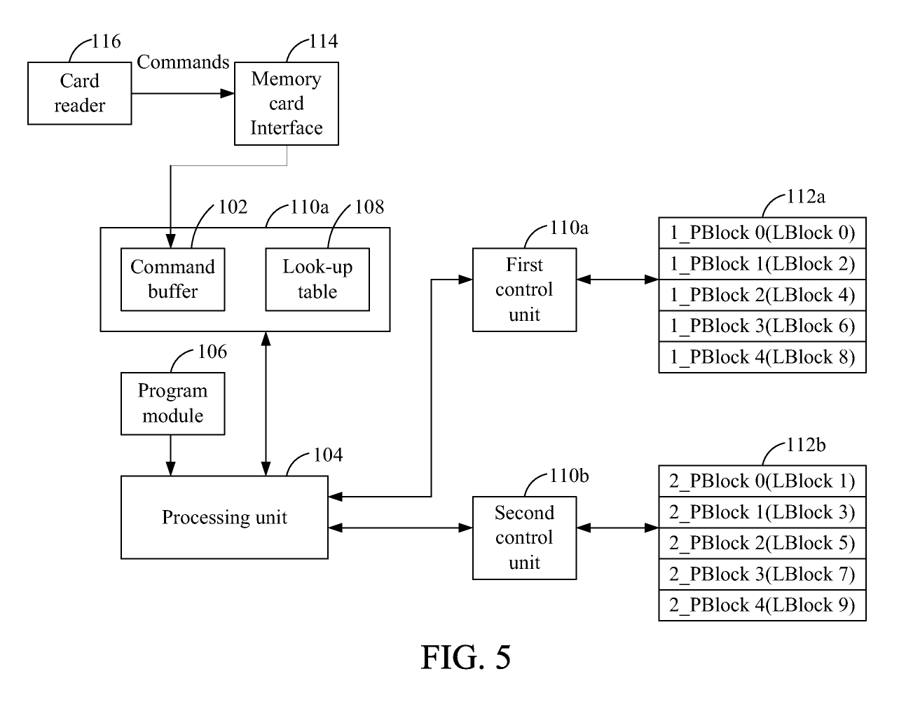

Please refer to FIGS. 1-4 and FIG. 5. FIG. 5 is a schematic view of the storage device having the parallel processing architecture according to one embodiment of the present invention. The storage device is memory card device and/or solid state device (SSD), wherein the memory card device may be secure digital card (SD card), memory stick card (MS card), compact flash card (CF card) and multi-media card (MMC card). The parallel processing architecture (100, 200, and 300) is connected to the card reader 116 via the memory card interface 114. In one case, the memory card interface 114 is integrated into the parallel processing architecture (100, 200, and 300). The card reader 116 is coupled to the computer system and includes portable electronic products. The memory card interface 114 is used to transmit the command from the computer system and/or portable electronic products to the processing unit 104 of the parallel processing architecture (100, 200, and 300). The detailed operations in FIG. 5 are the same as the descriptions in FIGS. 1-4.

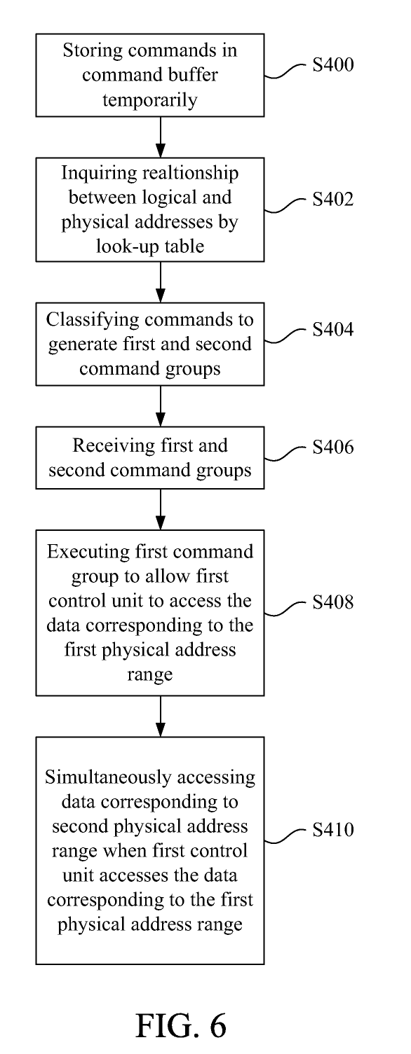

Please refer FIGS. 1-2 and FIG. 6. FIG. 6 is a flow chart of parallel processing method of the flash memory according to one embodiment of the present invention. The parallel processing architecture (100, 200, and 300) includes a command buffer 102, processing unit 104, a first control unit 110a, a second control unit 110b, a first memory unit 112a, a second memory unit 112b, a look-up table 108, a first look-up table 108a, and a second look-up table 108b. The parallel processing method of the flash memory includes following steps:

In step S400, a command buffer 102 stores a plurality of commands temporarily.

In step S402, a look-up table 108 stores the corresponding relationship between the first logical address blocks of the data and the first physical blocks, and stores the corresponding relationship between the second logical address blocks of the data and the second physical blocks. The processing unit 104 utilizes the look-up table 108 to inquire the first physical address range corresponding to the first data address group and the second physical address range corresponding to the second data address group. In another case, a first look-up table 108a stores the corresponding relationship between the first logical address blocks of the data, and a second look-up table 108b stores the corresponding relationship between the second logical address blocks of the data and the second physical blocks. The first control unit 110a utilizes the first look-up table 108a to inquire the first physical address range corresponding to the first data address group, and the second control unit 110b utilizes the second look-up table 108b to inquire the second physical address range corresponding to the second data address group.

In step S404, the processing unit 104 classifies the commands to generate a first command group and a second command group, wherein the first command group is associated with a first data address group and the second command group is associated with a second data address group, and the first data address group is composed of a plurality of first logical address blocks and the second data address group is composed of a plurality of second logical address blocks. In one case, the processing unit 104 uses address mapping relationship between the logical address and physical address recorded in the look-up table (108, 108a, and 108b) to classify the commands.

In step S406, the first control unit 110a receives the first command group and the second control unit 110b receives the second command group.

In step S408, the processing unit 104 executes the first command group to allow the first control unit to access the data corresponding to the first physical address range of a first memory unit, wherein the first memory unit has a plurality of first physical blocks which have a first physical address range, and the first data address group corresponds to the first physical address range.

In step S410, the second control unit 110b simultaneously accesses the data of a second memory unit corresponding to the second physical address range when the first control unit 110a accesses the data corresponding to the first physical address range of the first memory unit 112a. The second memory unit 112b has a plurality of second physical blocks which have a second physical address range corresponding to the second data address group and the first physical address is different from the second physical address.

In one case, the units of the first physical block and the second physical block are identical to the units of the first logical address block and the second logical address block. In another case, the units of the first physical blocks are identical to the maximum memory accessing unit of an operating system (OS) which transmits the commands. The units which the first control unit accesses the first physical address and the second control unit accesses the second physical address are the same as the units which the first control unit erases the first physical address and the second control unit erases the second physical address. The units of the first physical address and the second physical address are block. The first physical address range and the second physical address range are positioned in form of an interlaced arrangement. In the present invention, the logic address block is adjustable so that the unit of the logical address is equal to the physical address and/or the ratio between the logical address and physical address is determined for increasing the accessing speed.

According to the above-mentioned descriptions, the parallel processing architecture of the present invention performs a plurality of commands and processing multiple input/output data streams during a time interval to increase the accessing speed of the flash memory. In addition, the unit for accessing the flash memory is the same as the unit for erasing the flash memory to increase the accessing efficiency of the flash memory.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A parallel processing architecture of flash memory, the parallel processing architecture comprising:
a command buffer, for storing a plurality of commands temporarily;
a processing unit, for classifying the commands to generate a first command group and a second command group, wherein the first command group is associated with a first data address group and the second command group is associated with a second data address group, and the first data address group is composed of a plurality of first logical address blocks and the second data address group is composed of a plurality of second logical address blocks;
a first control unit coupled to the processing unit;
a second control unit coupled to the processing unit;
a first memory unit coupled to the first control unit and having a plurality of first physical blocks which have a first physical address range, wherein the first data address group corresponds to the first physical address range and the processing unit executes the first command group to allow the first control unit to access the data corresponding to the first physical address range; and
a second memory unit coupled to the second control unit and having a plurality of second physical blocks which have a second physical address range, wherein the second data address group corresponds to the second physical address range and the second control unit simultaneously accesses the data corresponding to the second physical address range when the first control unit accesses the data corresponding to the first physical address range of the first memory unit.

2. The parallel processing architecture of claim 1, further comprising a look-up table coupled to the processing unit for storing the corresponding relationship between the first logical address blocks of the data and the first physical blocks, and for storing the corresponding relationship between the second logical address blocks of the data and the second physical blocks.

3. The parallel processing architecture of claim 2, wherein the processing unit utilizes the look-up table to classify the commands based on the corresponding relationship between the first logical address blocks and the first physical blocks, and based on the corresponding relationship between the second logical address blocks and the second physical blocks.

4. The parallel processing architecture of claim 2, wherein the processing unit utilizes the look-up table to inquire the first physical address range corresponding to the first data address group and the second physical address range corresponding to the second data address group.

5. The parallel processing architecture of claim 1, further comprising:
a first look-up table coupled to the processing unit, for storing the corresponding relationship between the first logical address blocks of the data; and
a second look-up table coupled to the processing unit, for storing the corresponding relationship between the second logical address blocks of the data and the second physical blocks.

6. The parallel processing architecture of claim 5, wherein the processing unit utilizes the first look-up table and the second look-up table to classify the commands based on the first logical address blocks and the second logical address blocks.

7. The parallel processing architecture of claim 5, wherein the first control unit utilizes the first look-up table to inquire the first physical address range corresponding to the first data address group, and the second control unit utilizes the second look-up table to inquire the second physical address range corresponding to the second data address group.

8. The parallel processing architecture of claim 1, wherein the first physical address range and the second physical address range are positioned in form of an interlaced arrangement.

9. The parallel processing architecture of claim 1, wherein the units of the first physical block and the second physical block are identical to the units of the first logical address block and the second logical address block.

10. The parallel processing architecture of claim 1, wherein the units of the first physical blocks are identical to the maximum memory accessing unit of an operating system (OS) which transmits the commands.

11. The parallel processing architecture of claim 1, further comprising:
a third memory unit coupled to the first control unit and having a plurality of third physical blocks which have the first physical address range, wherein the first data address group corresponds to the first physical address range and the processing unit executes the first command group to allow the first control unit to access the data of the third memory unit corresponding to the first physical address range; and
a fourth memory unit coupled to the second control unit and having a plurality of fourth physical blocks which have the second physical address range, wherein the second data address group corresponds to the second physical address range and the second control unit simultaneously accesses the data corresponding to the second physical address range when the first control unit accesses the data corresponding to the first physical address range of the fourth memory unit.

12. A parallel processing architecture of flash memory which is applicable to a memory card device, the parallel processing architecture comprising:
a memory card interface, for receiving a plurality of commands;
a command buffer, for storing a plurality of commands temporarily;
a processing unit, for classifying the commands to generate a first command group and a second command group, wherein the first command group is associated with a first data address group and the second command group is associated with a second data address group, and the first data address group is composed of a plurality of first logical address blocks and the second data address group is composed of a plurality of second logical address blocks;
a first control unit coupled to the processing unit;
a second control unit coupled to the processing unit;
a first memory unit coupled to the first control unit and having a plurality of first physical blocks which have a first physical address range, wherein the first data address group corresponds to the first physical address range and the processing unit executes the first command group to allow the first control unit to access the data corresponding to the first physical address range; and
a second memory unit coupled to the second control unit and having a plurality of second physical blocks which have a second physical address range, wherein the second data address group corresponds to the second physical address range and the second control unit simultaneously accesses the data corresponding to the second physical address range when the first control unit accesses the data corresponding to the first physical address range of the first memory unit.

13. The parallel processing architecture of claim 12, further comprising a look-up table coupled to the processing unit for storing the corresponding relationship between the first logical address blocks of the data and the first physical blocks, and for storing the corresponding relationship between the second logical address blocks of the data and the second physical blocks.

14. The parallel processing architecture of claim 13, wherein the processing unit utilizes the look-up table to classify the commands based on the corresponding relationship between the first logical address blocks and the first physical blocks, and based on the corresponding relationship between the second logical address blocks and the second physical blocks.

15. The parallel processing architecture of claim 13, wherein the processing unit utilizes the look-up table to inquire the first physical address range corresponding to the first data address group and the second physical address range corresponding to the second data address group.

16. The parallel processing architecture of claim 12, further comprising:
a first look-up table coupled to the processing unit, for storing the corresponding relationship between the first logical address blocks of the data; and
a second look-up table coupled to the processing unit, for storing the corresponding relationship between the second logical address blocks of the data and the second physical blocks.

17. The parallel processing architecture of claim 16, wherein the processing unit utilizes the first look-up table and the second look-up table to classify the commands based on the first logical address blocks and the second logical address blocks.

18. The parallel processing architecture of claim 16, wherein the first control unit utilizes the first look-up table to inquire the first physical address range corresponding to the first data address group, and the second control unit utilizes the second look-up table to inquire the second physical address range corresponding to the second data address group.

19. The parallel processing architecture of claim 12, wherein the first physical address range and the second physical address range are positioned in form of an interlaced arrangement.

20. The parallel processing architecture of claim 12, wherein the units of the first physical block and the second physical block are identical to the units of the first logical address block and the second logical address block.

21. The parallel processing architecture of claim 12, wherein the units of the first physical blocks are identical to the maximum memory accessing unit of an operating system (OS) which transmits the commands.

22. The parallel processing architecture of claim 12, further comprising:
a third memory unit coupled to the first control unit and having a plurality of third physical blocks which have the first physical address range, wherein the first data address group corresponds to the first physical address range and the processing unit executes the first command group to allow the first control unit to access the data of the third memory unit corresponding to the first physical address range; and
a fourth memory unit coupled to the second control unit and having a plurality of fourth physical blocks which have the second physical address range, wherein the second data address group corresponds to the second physical address range and the second control unit simultaneously accesses the data corresponding to the second physical address range when the first control unit accesses the data corresponding to the first physical address range of the fourth memory unit.

23. A parallel processing method of flash memory, comprising the steps of:
(a) temporarily storing a plurality of commands in a command buffer;
(b) classifying the commands by a processing unit to generate a first command group and a second command group, wherein the first command group is associated with a first data address group and the second command group is associated with a second data address group, and the first data address group is composed of a plurality of first logical address blocks and the second data address group is composed of a plurality of second logical address blocks;
(c) receiving the first command group by a first control unit and receiving the second command group by a second control unit;
(d) executing the first command group by a processing unit to allow the first control unit to access the data corresponding to the first physical address range of a first memory unit, wherein the first memory unit has a plurality of first physical blocks which have a first physical address range, and the first data address group corresponds to the first physical address range; and
(e) simultaneously accessing the data of a second memory unit corresponding to the second physical address range by the second control unit when the first control unit accesses the data corresponding to the first physical address range of the first memory unit.

24. The parallel processing method of claim 23, before the step (b), further comprising a step (b1): utilizing a look-up table for storing the corresponding relationship between the first logical address blocks of the data and the first physical blocks, and for storing the corresponding relationship between the second logical address blocks of the data and the second physical blocks.

25. The parallel processing method of claim 24, wherein during the step (b), the processing unit utilizes the look-up table to classify the commands based on the corresponding relationship between the first logical address blocks and the first physical blocks, and based on the corresponding relationship between the second logical address blocks and the second physical blocks.

26. The parallel processing method of claim 24, wherein during the step (b1), the processing unit utilizes the look-up table to inquire the first physical address range corresponding to the first data address group and the second physical address range corresponding to the second data address group.

27. The parallel processing method of claim 23, before the step (b), further comprising the steps of:
(b2) utilizing a first look-up table coupled to the processing unit for storing the corresponding relationship between the first logical address blocks of the data; and
(b3) utilizing a second look-up table coupled to the processing unit for storing the corresponding relationship between the second logical address blocks of the data and the second physical blocks.

28. The parallel processing method of claim 27, wherein the processing unit utilizes the first look-up table and the second look-up table to classify the commands based on the first logical address blocks and the second logical address blocks.

29. The parallel processing method of claim 27, wherein the first control unit utilizes the first look-up table to inquire the first physical address range corresponding to the first data address group, and the second control unit utilizes the second look-up table to inquire the second physical address range corresponding to the second data address group.

30. The parallel processing method of claim 23, wherein the units of the first physical block and the second physical block are identical to the units of the first logical address block and the second logical address block.

31. The parallel processing method of claim 23, wherein the units of the first physical blocks are identical to the maximum memory accessing unit of an operating system (OS) which transmits the commands.
